(19) United States
(12) Patent Application Publication
(10) Pub. No.: US 2013/0059043 A1
(43) Pub. Date: Mar. 7, 2013

(54) PROCESS FOR AFTERTREATMENT OF VINEGAR OBTAINED BY FERMENTATION

(71) Applicants: Holger Hielscher, Teltow (DE); Thomas Hielscher, Stahnsdorf (DE); Harald Hielscher, Stahnsdorf (DE)

(72) Inventors: Holger Hielscher, Teltow (DE); Thomas Hielscher, Stahnsdorf (DE); Harald Hielscher, Stahnsdorf (DE)

(73) Assignee: Dr. Hielscher GmbH, Teltow (DE)

(21) Appl. No.: 13/698,671

(22) PCT Filed: May 19, 2011
(86) PCT No.: PCT/EP2011/058115

§ 371 Date: Nov. 19, 2012

Related U.S. Application Data
(60) Provisional application No. 61/347,844, filed on May 25, 2010.

(51) Int. Cl. A23L 1/025

(52) U.S. Cl. 426/238

(57) ABSTRACT

The invention relates to a method for the after-treatment of a vinegar obtained by fermentation. The method is characterized in that the vinegar is treated with ultrasound by means of an ultrasonic device, by taking into account the following parameters:
amplitude 0.1 to 150 μm
frequency 10 to 200 kHz
surface intensity of the ultrasonic treatment 0.001 to 200 W/cm²
power per ultrasonic device used 20 to 20000 W
net energy input 0.01 to 2000 kWh/m³
volume-related power input 0.001 to 100 W/mL
liquid pressure 0.1 to 50 bar, and
temperature −2 to 150° C.

The ultrasonic treatment of the vinegar obtained by fermentation has an influence on the sensory, optical and microbial quality of the vinegar and influences the storability and effect thereof.

The invention relates to a method for the after-treatment of a vinegar obtained by fermentation.

### BACKGROUND OF THE INVENTION

Vinegar is a condiment, a preservative and a luxury food with a sour taste, which is produced by the fermentation of alcohol-containing liquids by acetic acid bacteria. The acetic acid concentration of table vinegar is between 4-8%. The acetic acid concentration of vinegar used for pickled vegetables may go up to 15.5%.

The preparation of vinegar is one of the oldest food production methods of mankind. The basic product for fermentation vinegars is alcohol, which is primarily obtained from plant material when used for vinegar as a foodstuff. Depending on the starting material a difference can be made between vinegar from alcohol (e.g. white vinegar, brandy vinegar, alcoholic vinegar, balsamic vinegar), wine vinegar (made from wine, excess wine or waste wine), vinegar made from floury substances (e.g. malt vinegar, beer vinegar, potato vinegar, rice vinegar), fruit vinegar (made from fruit juice, e.g. apple vinegar, cherry vinegar, banana vinegar), and flavored vinegars which are modified by the subsequent addition of flavoring substances. The appreciated balsamic vinegar—“Aceto Balsamico tradizionale de Modena”—is a balsamic acid made from the Trebbiano grape, which is produced in a traditional, time-consuming and expensive method.

The production of vinegar requires a time-consuming production process, in particular if the vinegars are high quality ones. Vinegar, a sour liquid, is produced by the oxidative fermentation of ethanol. The mother of vinegar, a substance of cellulose and acetic acid bacteria, converts the alcohol to acetic acid while oxygen is added. During this oxidation process the acid is produced which gives the vinegar its typical sour taste and slightly pungent smell. The chemical reaction by which the acetic acid bacteria (acetobacter aceae) convert the alcohol into vinegar reads: “C₂H₅OH+O₂→CH₃COOH+H₂O.

A plurality of methods have established themselves for the production of vinegar, inter alia, the open fermentation method, the submerged fermentation method, the Orléans method, the fast vinegar method and the Venturi method.

Similar to the wine production, the maturation is of great significance. The length of the maturation and the storage are important factors and determine the quality of the end product. While a less expensive vinegar only has a maturation period of approximately years, high-quality vinegars are partially stored for 30 years or longer. Also the storage container has an influence on the later end product. Less expensive vinegars are left to mature in plastic or steel tanks, while high-quality vinegars mature in wooden barrels, with due regard to the various types of wood (e.g. oak, cherry, chestnut).

After-treatment methods are used to increase the storability or achieve an unchanging product quality of the fermented vinegar. In particular, it should be prevented that the smell, color and taste deteriorate by undesired biological or chemical processes in the fermented vinegar.

### SUMMARY OF THE INVENTION

One or more of the above-mentioned problems can be solved, or at least reduced, by means of the method according to the invention.

The method according to the invention for the after-treatment of a vinegar obtained by fermentation is characterized in that the vinegar is treated with ultrasound by means of an ultrasonic device, by taking into account the following parameters. The vinegar is:
exposed to ultrasonic waves with an amplitude between 0.1 and 150 μm, for a mild ultrasonic treatment in particular with 1 to 20 μm, e.g. 10 μm; for an intensive ultrasonic treatment in particular with 30 to 80 μm, e.g. 55 μm. Further variations are possible, as the amplitude may be controlled or uncontrolled during the exposure to ultrasonic waves, the exposure to ultrasonic waves may be performed with automatic balancing or without automatic balancing and/or the exposure to ultrasonic waves may be carried out under pressure or without pressure;
exposed to ultrasonic waves at a frequency between 10 to 200 kHz, in particular 15 to 40 kHz, e.g. 20 kHz;
exposed to ultrasonic waves with a surface intensity of 0.001 to 200 W/cm², in particular 5 to 70 W/cm², e.g. 35 W/cm²;
exposed to ultrasonic waves with a power of 20 to 20000 W, in particular 1000 to 10000 W, e.g. 4000 W, per ultrasonic device used. The ultrasonic energy may here be inputted by a piezoelectric or magnetostrictive sound transducer, e.g. a piezoelectric push-pull sound transducer, an ultrasonic bath or tank, an immersible ultrasonic plate, a ring sonotrode, a cascade sonotrode or a bar sonotrode, in particular by a cascade and bar sonotrode, e.g. a cascade sonotrode;
exposed to ultrasonic waves with a net energy input of 0.01 to 2000 kWh/m³, in particular kWh/m³, e.g. kWh/m³. For a mild exposure to ultrasonic waves a net energy input of 0.1 to 1.0 kWh/m³, in particular between 0.1 and 1.0 kWh/m³, e.g. 0.5 kWh/m³, is assessed. For a moderate exposure to ultrasonic waves a net energy input of 1.0 to 10 kWh/m³, in particular between 1.0 and 5.0 kWh/m³, e.g. 2.5 kWh/m³, is assessed. For an intensive exposure to ultrasonic waves a net energy input of 10 to 2000 kWh/m³, in particular between 10 and 100 kWh/m³, e.g. 20 kWh/m³, is assessed.
exposed to ultrasonic waves with a volume-related power input of 0.001 to 100 W/mL, in particular 1 to 10 W/mL, e.g. 5 W/mL;
exposed to ultrasonic waves at a liquid pressure of 0.1 to 50 bar (a), in particular 1 to 10 bar (a), e.g. 2 bar (a); and
exposed to ultrasonic waves at temperatures of −2 to 150° C., in particular 10 to 50° C., e.g. 20° C.

The ultrasonic waves are transmitted to the liquid, the vinegar, by means of an ultrasonic device, the ultrasound being a low-frequency high-power ultrasound (LFHP-US).

The ultrasonic process may be applied prior to the fermentation, during the fermentation and/or after the fermentation, whereby the exposure to the ultrasonic waves can take place directly after the fermentation, after the storage, prior to bottling, during the bottling and/or during the transport. The ultrasonic treatment process with ultrasound can be carried out in the batch or in the continuum, whereby the exposure to ultrasonic waves in the continuum can be accomplished with a single pass inline or in the recirculation system, and the batch ultrasonic treatment is carried out, for instance, in the tank, container, barrel or bottle. To support the ultrasonic effect static mixers, stirrers or agitators may be used. When the ultrasonic treatment is carried out the detention time in the ultrasonic reactor or ultrasonic flow cell may be between 0.1 sec and 24 h, in particular 0.5 sec to 60 sec, e.g. 20 sec.

The effects on vinegar described below are achieved by coupling in ultrasound, whereby the generation of ultrasonic cavitation, which creates liquid jets of up to 1000 km/h, locally extremely high temperatures (about 5000 K) and pressures (about 2000 atm) as well as enormous heating and cooling rates (>10⁹ Ks⁻¹) by the imploding cavities in the liquid. The ultrasonic waves are transmitted to the liquid, the vinegar, by an ultrasonic device. The cavitation effects resulting therefrom cause the described effects, which can be observed in the vinegar with regard to the sensory, optical and microbial quality, the effectiveness of the active ingredients and the storability.

Accordingly, if vinegar is treated with ultrasound, the following effects can be achieved:

Coupling ultrasonic waves into the vinegar brings about a significant improvement of the sensory quality, which is indicated by an alteration of the sour taste of the vinegar. The vinegar becomes clearly milder, rounder and tastier, whereby special tastes of the vinegar product, e.g. the acidity or sweetness, can be intensified or weakened. The ultrasonic treatment has an influence on the taste, color, flavor, tolerance, stability, gas concentration, acid, pH-value, viscosity, transparency, mildness as regards the taste, spiciness, maturity, complexity as well as the yeast taste. If vinegar was exposed to ultrasound an alteration in the taste can be observed, which can only be obtained by a long maturing time in the conventional production methods.

The improvement of the sensory features of the vinegar may be the result of different effects triggered by the ultrasound, including the initiation, stimulation or avoidance of chemical and/or catalytic reactions which are triggered by sonochemical and/or sonocatalytic effects and by means of which certain components of the vinegar show a reaction without additional input factors, so that, for instance, the effect of the accelerated maturation and aging occurs, or chemical reactions with the vinegar, e.g. oxidation or accelerated maturation and aging, are initiated by additionally inputted factors, e.g. metals or alumina. Ultrasound improves the reaction kinetics, and novel reactions in the vinegar can be initiated. Ultrasonic energy inputted into vinegar is capable of generating extraction effects and/or disintegration effects, which have an effect on the microbial system, the acetogenic bacteria, yeast cells, spores and other microbes, in particular acetogenic bacteria and yeasts, e.g. acetic acid bacteria. Furthermore, ultrasound is capable of extracting components from plant material, e.g. grape skin, pulp, must or wood, for instance, oak (e.g. shavings, powder, chips, sticks), herbs and spices, e.g. oregano, thyme, chili, garlic. Ultrasonic energy inputted into vinegar may be used for the dispersion of and/or for homogenizing and/or dissolving natural ingredients of the vinegar, the vinegar components as well as of added substances, such as natural and/or artificial flavors, e.g. raspberry, pear, fig, and/or natural and/or artificial colorants, e.g. purple or magenta, and/or tannins, e.g. as distillate or resin, and/or vitamins, as well as of powders, e.g. sugar, soluble or insoluble cellulose, starch and/or crystals, e.g. sugar, caramel, salts, soluble or insoluble cellulose. Furthermore, ultrasonic energy inputted into vinegar can generate the dilution of highly concentrated additives, e.g. syrup and or flavor concentrates, and the emulsification of non-mixable liquids, e.g. oils, in particular omega-3 fatty acids, and/or colorants, and contribute to the modification of the taste, the coloring and/or preservation. The preservation is achieved and/or improved by the ultrasound-generating effects of degassing, e.g. removing microbubbles and/or dissolved gases, of breaking and the lysis of cells, e.g. microbes, spores, yeasts and/or bacteria, in particular the Mycoderma aceti, Turbatrix aceti and Nematoda, of heating and/or pasteurizing.

Furthermore, the ultrasound improves the storability. This effect is achieved by microbial inactivation and the degassing. The exposure of vinegar to ultrasound can, moreover, have an influence on the medical effect of the product, whereby an impact can be observed on the cholesterol effects and the triacylglycerol effects, on the blood sugar level and the blood sugar adjustment, on the effectiveness against infections, as well as the improvement of the antibacterial cleaning effects and a reduced risk of hypokalaemia, hyperreninemia and osteoporosis.

The input of ultrasonic energy into vinegar allows the realization of one, more or all of the above-described effects.
For the commercial production of vinegar the use of an ultrasonic method is of great significance insofar as a qualitatively superior product can be produced by means of ultrasound, while the production time and the maturing period can be significantly reduced.

1. Method for the after-treatment of a vinegar obtained by fermentation, characterized in that the vinegar is treated with ultrasound by means of an ultrasonic device, by taking into account the following parameters:
amplitude 0.1 to 150 μm
frequency 10 to 200 kHz
surface intensity of the ultrasonic treatment 0.001 to 200 W/cm²
power per ultrasonic device used 20 to 20000 W
net energy input 0.01 to 2000 kWh/m³
volume-related power input 0.001 to 100 W/mL
liquid pressure 0.1 to 50 bar, and
temperature −2 to 150° C.

2. Method according to claim 1, wherein the frequency is 15 to 40 kHz.

3. Method according to claim 1, wherein the surface intensity of the ultrasonic treatment is 5 to 70 W/cm².

4. Method according to claim 1, wherein the power per ultrasonic device used is 1000 to 10000 W.

5. Method according to claim 1, wherein the volume-related power input is 1 to 10 W/mL.

6. Method according to claim 1, wherein the liquid pressure is 1 to 10 bar.

7. Method according to claim 1, wherein the temperature is 10 to 50° C.
